(19) United States
(12) Patent Application Publication
(10) Pub. No.: US 2009/0273433 A1
(43) Pub. Date: Nov. 5, 2009

(54) METHOD OF AUTOMATICALLY PROGRAMMING A NEW BALLAST ON A DIGITAL BALLAST COMMUNICATION LINK

(76) Inventors: Christopher J. Rigatti, Pittsburgh, PA (US); Frank H. Benetz, Slatedale, PA (US)

Correspondence Address: OSTROLENK FABER GERB & SOFFEN, 1180 AVENUE OF THE AMERICAS, NEW YORK, NY, 100368403, US

(21) Appl. No.: 12/481,285

(22) Filed: Jun. 9, 2009

Related U.S. Application Data
(63) Continuation-in-part of application No. 11/948,408, filed on Nov. 30, 2007.
Application No. 11/948,408 is a division of application No. 11/375,462, filed on Mar. 13, 2006, now Pat. No. 7,391,297.
(60) Provisional application No. 60/661,055, filed on Mar. 12, 2005.

(51) Int. Cl. G05B 23/02

(52) U.S. Cl. 340/3.5

(57) ABSTRACT

A method for replacing a previously-installed lighting control device with a newly-installed lighting control device in a lighting control system provides for automatic programming of the newly-installed device if there is only one newly-installed device in the system. The system comprises a controller interconnected to the newly-installed device by a communication link. The controller stores a short address and configuration information of the previously-installed device in memory and assigns the short address of the previously-installed device to the newly-installed device. The controller is operable to transmit the configuration information associated with the previously-installed device to the newly-installed device in response to determining that there is only one newly-installed device in the system. The controller is operable to undo the completed address assignment by unassigning the short address from the newly-installed device if there is more than one newly-installed device in the system.

### CROSS-REFERENCE TO RELATED APPLICATIONS

This application is a continuation-in-part of commonly-assigned U.S. patent application Ser. No. 11/948,408, filed Nov. 30, 2007, which is a divisional of U.S. patent application Ser. No. 11/375,462, filed Mar. 13, 2006, now U.S. Pat. No. 7,391,297, which claims priority from U.S. Provisional Patent Application Ser. No. 60/661,055, filed Mar. 12, 2005. The entire disclosures of all above-referenced patents and patent applications are hereby incorporated by reference.

### BACKGROUND OF THE INVENTION

1. Field of the Invention

The present invention relates generally to a load control system for controlling the amount of power delivered to a plurality of electrical loads, and, more particularly, to a method of automatically programming a new ballast that is installed to replace a previously-installed ballast in a multi-ballast lighting control system.

2. Description of the Related Art

Remote control and monitoring of electrical/electronic devices, such as load control devices of a lighting control system, is known. For example, the Digital Addressable Lighting Interface (“DALI”) communication protocol allows for digital addressing of the control devices of lighting control systems. Control devices can use the DALI protocol to communicate with a load control device, for example, to adjust the intensity of a lighting load, by sending commands over a communication network. Using the DALI protocol, each control device has its own individual digital address, thus enabling remote communication with the control device. Accordingly, loads can be switched on and off by commands issued by a remote console. A central controller processes the commands and issues commands in response to control the load control devices. The load control device may be operable to control, for example, a lighting load, such as an incandescent lamp or a fluorescent lamp, or a motor load, such as a motorized window treatment.

In recent years, large-scale lighting systems have been developed to meet the needs of lighting applications with distributed resources and centralized control. Building lighting systems are often controlled on a floor-by-floor basis or as a function of the occupancy space used by independent groups in the building. Taking a floor of a building as an example, each room on the floor may have different lighting requirements depending on a number of factors including occupancy, time of day, tasks ongoing in a given room, security and so forth, for example. When a number of rooms are linked together for lighting purposes, control of lighting in those rooms can be centralized over a network. While power to various lighting modules can be supplied locally, control functions and features of the lighting system can be directed through a control network that sends and receives messages between a controller and various lighting system components. For instance, a room with an occupancy sensor may deliver occupancy-related messages over the network to inform the controller of the occupancy condition of the given room. If the room becomes occupied, the lighting controller can cause the lighting in that room to turn on, or be set to a specified dimming level.

When messages are exchanged in the lighting control network, a protocol is employed to permit the various network components to communicate with each other. The DALI protocol represents a convention for communication adopted by lighting manufacturers and designers to permit simple messages to be communicated over a lighting network in a reasonably efficient manner. The DALI protocol calls for a 19-bit message to be transmitted among various network components to obtain a networked lighting control. The 19-bit message is composed of address bits and command bits, as well as control bits for indicating the operations to be performed with the various bit locations and the message. For example, one type of message provides a 6-bit address and an 8-bit command to deliver a command to the addressed network component. By using this protocol technique, sixty-four different devices may be addressed on the lighting network to provide the network control. A large number of commands can be directed to the addressable devices, including such commands as setting a power-on level, fade time and rates, group membership and so forth.

A conventional lighting control system, such as a system conforming to the DALI protocol, includes a hardware controller for controlling ballasts in the system. Typically, the controller is coupled to the ballasts in the system via a single digital serial interface, wherein data is transferred. A disadvantage of this single interface is that the bandwidth of the interface limits the amount of message traffic that can reasonably flow between the controller and the ballasts. This can also create delays in times to commands.

Typical DALI lighting control systems require a “bus power supply,” which supplies power to the DALI communication bus. The DALI communication bus consists of a two-wire link with one wire supplying a DC link voltage, e.g., 18 VDC, and the other wire as common. The bus power supply generates the DC link voltage required to allow the devices on the DALI bus to communicate. In order to transmit a bit on the DALI communication bus, a device will “short” out the link for a brief period of time. If the bus power supply fails, the devices connected to the DALI bus will not be able to communicate.

A prior art electronic dimming ballast may comprise a front end, which includes a rectifier for producing a rectified DC voltage from an AC mains supply and a boost converter for generating a boosted DC bus voltage from the rectified DC voltage. The DC bus voltage is provided to a back end, which includes an inverter for generating a high-frequency AC voltage from the DC bus voltage and an output filter for coupling the high-frequency AC voltage to the lighting load for powering the lighting load. The front end and the back end of a prior art ballast is described in greater detail in U.S. Pat. No. 6,674,248, issued Jan. 6, 2004, entitled ELECTRONIC BALLAST, the entire disclosure of which is incorporated herein by reference.

Often, the ballast may include a processing section, for example, comprising a microprocessor, which receives multiple inputs. The inputs may be received from the ballast itself, e.g., an input concerning the magnitude of the DC bus voltage or an input concerning the output lamp current or the output lamp voltage. In addition, the inputs to the processing section may be received from an external sensor, such as an external photocell sensor or an external occupancy sensor. Furthermore, the processing section has a communication port that transmits and receives information via the DALI communications protocol. The processing section is powered by a power supply, which receives the rectified DC voltage from the rectifying circuit. An example of a ballast that comprises a microprocessor and in operable to receive a plurality of inputs, specifically, inputs from external sensors, is described in greater detail in U.S. patent application Ser. No. 10/824,248, filed Apr. 14,2004, entitled MULTIPLE INPUT ELECTRONIC BALLAST WITH PROCESSOR, the entire disclosure of which is incorporated herein by reference.

Systems for wirelessly controlling an electrical device are also known. For example, some prior art systems are operable to control the status of electrical devices such as electric lamps, from a remote location via wireless communication links, including radio frequency (RF) links or infrared (IR) links. Status information regarding the electrical devices (e.g., on, off and intensity level) is typically transmitted between specially adapted lighting control devices and at least one master control unit. One example prior art system that includes configurable devices and wireless control devices that are provided by the assignee of the present patent application is commercially known as the RADIO RA wireless lighting control system. The RADIO RA system is described in greater detail in U.S. Pat. No. 5,905,442, issued May 18, 1999, entitled, METHOD AND APPARATUS FOR CONTROLLING AND DETERMINING THE STATUS OF ELECTRICAL DEVICES FROM REMOTE LOCATIONS, the entire disclosure of which is incorporated herein by reference.

In spite of the convenience provided by remote control and monitoring systems, such as provided by the DALI protocol, control devices that may be physically located far from each other or are otherwise disparate devices, each having its own individual digital address, must be individually selected and configured to the group, typically by referencing a table of devices and/or zones. When faced with a massive list of thousands of individual control devices, the task associated with defining various groups of individual devices is daunting.

Accordingly, configuring a prior art lighting control system can take a substantial amount of time. For example, each of the individual load control devices and the associated lighting load may identified by name or number in a table, and must be located by a user in order to add the load control device to a group. Further, a plurality of individual lighting fixtures may be assigned to respective zones. Accordingly, a user must navigate through a large table of many zones, each representing a plurality of lighting fixtures, in order to define groups of lights for various patterns, such as described above. Such a table of zones is not intuitive, and tasks associated with defining various lighting patterns based upon hundreds or even thousands of zones, many of which may include several or many lighting fixtures, is problematic.

The prior art lighting control systems provide a method for replacing a single ballast when a single ballast requires replacement, for example, due to a failure of the ballast. First, the failed ballast is removed and a new ballast is installed in its place. Next, a query is sent over the communication link from the controller to identify which particular ballast is unassigned. When the new and unassigned ballast responds, the controller transmits programming settings and configuration information of the failed ballast to the new ballast. The programming settings and configuration information are stored in the new replacement ballast. The programming settings and configuration information may include, for example, settings related to a high-end intensity level (e.g., a “high-end trim”), a low-end intensity level (e.g., a “low-end trim”), a fade time, and an emergency intensity level.

While automatic methods for ballast replacement may be useful to replace a single ballast, it is ineffective to replace a plurality of ballasts, since each of the plurality of ballast will require respective setting and configuration information transmitted thereto. Multiple unassigned ballasts cannot be distinguished from each other, and, accordingly, there is no way in the prior art to automatically provide respective setting and configuration information for each of a plurality of ballasts. If there is more than one unaddressed ballast on the communication link of the prior art lighting control system, errors may occur in the programming of one of the unaddressed ballasts if the prior art method for replacing a single ballast is used. Thus, there is a need for a method that automatically programs an unaddressed ballast if there is only a single unaddressed ballast on the communication link, but does not cause programming errors if there are multiple unaddressed ballasts.

### SUMMARY OF THE INVENTION

According to an embodiment of the present invention, an automatic single-ballast replacement procedure allows for replacing a previously-installed load control device with a new load control device in a load control system comprising a controller interconnected to the new load control device by a communication link. The previously-installed load control device has a short address associated therewith. The method comprises the steps of: (1) storing the short address and configuration information of the previously-installed load control device in a memory of the controller; (2) installing the new load control device in place of a previously-installed load control device; (3) the controller automatically assigning the short address of the previously-installed load control device to the new load control device; (4) the controller subsequently determining if there are unaddressed load control devices on the communication link; (5) the controller transmitting the configuration information associated with the previously-installed load control device to the new load control device in response to determining that there are not unaddressed load control devices on the communication link; and (6) the controller unassigning the short address from the new load control device in response to determining that there are unaddressed load control devices on the communication link.

In addition, a lighting control system for controlling the intensity of a lighting load is also described herein. The lighting system comprises a lighting control device coupled to a communication link and operable to adjust the intensity of a lighting load, and a controller coupled to the load control device via the communication link. The controller has a memory for storing a short address and an associated confirmation information. The controller automatically assigns the short address to the load control device after the load control device is installed on the communication link. The controller is further operable to subsequently determine if there are load control devices on the communication link, to transmit the configuration information associated with the short address to the load control device in response to determining that there are not unaddressed load control devices the communication link, and to unassign the short address from the load control device in response to determining that there are unaddressed load control devices the communication link.

According to another embodiment of the present invention, a method of automatically programming a lighting control system that comprises a first ballast and a bus supply interconnected by a communication bus comprises the steps of: (1) providing the first ballast with a first ballast configuration information; (2) assigning the first ballast a first short address; (3) storing in the bus supply the first ballast configuration information and the first short address of the first ballast; (4) removing the first ballast from the lighting control system; (5) installing in the lighting control system a second ballast and a third ballast; (6) automatically determining that the first ballast has been removed from the lighting control system; (7) automatically determining that the second ballast has not been assigned a short address; (8) assigning the first short address of the first ballast to the second ballast in response to determining that the second ballast has not been assigned a short address and that the first ballast has been removed from the lighting control system; (9) subsequently transmitting the first short address to the second ballast; (10) subsequently determining that the third ballast has not been assigned a short address; and (11) unassigning the first short address from the second ballast in response to determining that the third ballast has not been assigned a short address.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form of the invention, which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates a plurality of devices, including ballasts, infrared receivers, photosensors, occupancy sensors, wall controls, and a bus power supply communicating over a communication link;

FIG. 2 illustrates an example grid of light fixtures and ballasts arranged in rows and columns in a room having a window;

FIG. 3 is a flowchart of a ballast configuring process for configuring one or more ballasts using a handheld programming device;

FIG. 4 is a flowchart of a photosensor configuration procedure for configuring a daylight photosensor using the handheld programming device;

FIG. 5 is a flowchart of an occupancy sensor configuration procedure for configuring an occupancy sensor device using the handheld programming device;

FIG. 6 is a flowchart of a photosensor grouping procedure for configuring a group of ballasts with a particular photosensor using the handheld programming device;

FIG. 7 is a flowchart of an occupancy sensor grouping procedure for defining an occupancy sensor group using the handheld programming device;

FIG. 8 is a flowchart of an infrared grouping procedure for configuring a group of ballasts with a particular infrared receiver device using the handheld programming device;

FIG. 9 is a flowchart of a manual ballast replacement procedure for replacing one or a plurality of ballasts using the handheld programming device according to a first embodiment of the present invention;

FIG. 10 illustrates an example database record layout for a data table that stores configuration and setting information for ballasts, in accordance-with an example database stored on a bus power supply; and

FIGS. 11A and 11B show a flowchart of an automatic single-ballast replacement procedure according to a second embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed. Also, although the present invention is directed particularly to lighting controls, the present invention can be applied to communication signals for controlling the status of other kinds of devices, such as, for example, fan motors or motorized window treatments.

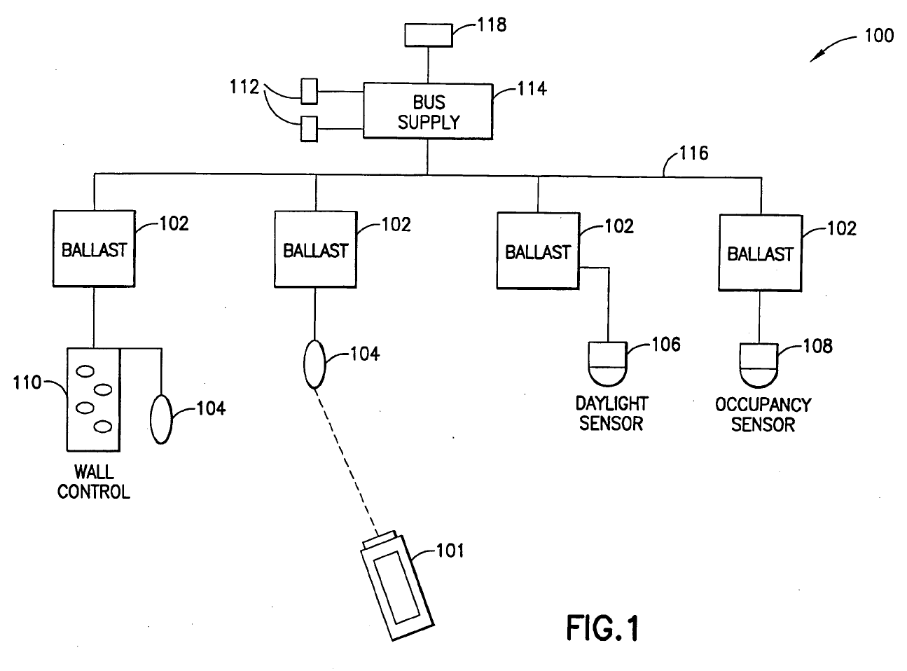

FIG. 1 shows an example hardware arrangement of components and devices in a building installation in accordance with a first embodiment of the present invention, which is referred herein generally as lighting control system 100. The devices of the lighting control system 100 comprise, for example, lighting control devices, such as ballasts 102, which may each be electrically coupled to an infrared receiver 104, a photosensor 106 (such as a daylight sensor), an occupancy sensor 108, or a wall control 110. The wall control 110 may also include an infrared receiver 104. The infrared receivers 104 are operable to receive infrared signals sent from a handheld programming device 101 and to send signals to the associated ballast 102.

A bus power supply 114 (also referred to herein as “bus supply”) is hard wired to a communication link 116, e.g. a DALI communication link, and provides a DC link voltage, e.g., 18 VDC, across the two wires of the communication link. The bus supply 114 operates as a digital ballast controller, i.e., the bus supply 114 is operable to store ballast programming information and to communicate with intelligent ballasts 102 over the communication link 116. The bus supply 114 comprises a microcontroller or other type of processor including a memory that stores a database 118 of the system ballasts and corresponding settings and configurations. The database 118 may comprise one or more data tables that are populated either automatically by individual ballasts transmitting respective information over the communication link 116, or by receiving signals transmitted by a handheld programming device 101. The bus supply 114 is operable to receive a plurality of contact closure inputs 112, which each provide an input of a closed state or an open state to the bus supply. The bus supply 114 is operable to control the lighting loads attached to each of the ballast 102 in response to a change in state of the contact closure inputs 112.

The handheld programming device 101 may include, for example, a graphical user interface that enables a user to select from various menu choices and transmit commands to the system 100 via the infrared receiver 104 and define various operating conditions. The infrared receiver 104 may include a light-emitting diode (LED), which illuminates when an infrared signal is being received and provides visual feedback to a user of the handheld programming device 101. Thus, the signals sent from the handheld programming device 101 represent instructions that, in accordance with the teachings herein, enable various tasks, including adjusting a lighting intensity level, configuring a sensor (e.g., the photosensor 106 or the occupancy sensor 108), defining ballast and/or sensor groups, configuring the wall control 110, performing diagnostics, and configuring or replacing a ballast, and replacing a bus supply. The handheld programming device 101 can be any handheld device operable to transmit commands via a wireless interface, such as infrared, radio frequency or other known wireless communication technology. The handheld programming device 101 may be a personal digital assistant (“PDA”) and configured with the PALM operating system, POCKET PC operating system, or other suitable operating system for a PDA. One skilled in the art will recognize that any manner of transmitting data or information in accordance with the teachings herein is envisioned.

Each ballast 102 is configured with a unique identifier, such as a serial number, that is assigned to the ballast during or after manufacture. In other words, the ballasts 102 are pre-configured “out of the box”, i.e., when the product is shipped with a serial number or other identifier assigned. The identifier can be a random number, or can include coded information, such as the location where the ballast was manufactured, the date the ballast was manufactured, features, etc. When one of the ballasts 102 is installed on the communication link 116, a second unique identifier, such as a system address, may be assigned to the ballast 102 and the second identifier is, thereafter, associated with the first identifier (e.g., the serial number). The second identifier value may be used as an index value in the database 118 of the bus supply 114. The bus supply 114 can use the second identifier, for example, to transmit instructions to the ballast 102. The second identifier is shorter in length than the first identifier (i.e., the second identifier comprises a “short” address). Accordingly, the bus supply 114 can transmit instructions to a respective ballast 102 faster by using the shorter second identifier. For example, the first identifier may be fourteen characters in length and the second identifier two characters in length.

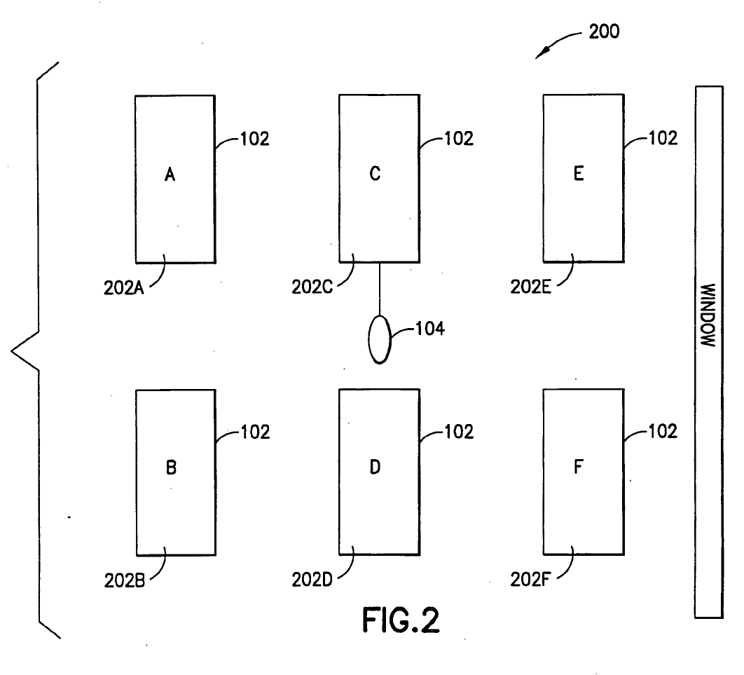

The lighting control system 100 may define particular lighting scenes, such that the ballasts 102 may be controlled to operate at various intensity levels depending on the respective location of each ballast within a room or building. FIG. 2 illustrates an example grid 200 of light fixtures and ballasts 102 arranged in a room having a window. During times of bright sunshine, light may enter the area adjacent to the grid 200 through the window and affect the lighting environment. Using the handheld programming device 101, a user can decrease the intensity setting for ballasts 102 that are located in sections 202E and 202F because of the fixtures' proximity to the window. For example, the ballasts 102 controlling fixtures in sections 202E and 202F can be defined to operate at 20% intensity. The ballasts 102 controlling fixtures in sections 202C and 202D can be defined to operate at 50% intensity. The ballasts 102 controlling fixtures in sections 202A and 202B can be defined to operate at 80% intensity. The user may use the handheld programming device 101 to define groups of ballasts with respective intensity levels, for example in rows and columns as shown.

The bus supply 114 stores the short address and configuration information (e.g., grouping information and respective operational settings) for the ballasts 102 in the database 118. For example, the database 118 may store values representing the row value, the gain value, and the short address (second unique identifier) of the ballast 102. The bus supply 114 may reference values in the database 118 to communicate commands to the ballasts 102 in the grid 200 in order to operate fixtures appropriately in accordance with instructions defined by a user using the handheld programming device 101.

The handheld programming device 101 may be used to configure ballasts, replace ballasts, set up sensor devices such as daylight sensors and occupancy sensors, and to define groupings of the various devices. Many of the examples shown in the flowcharts refer to an embodiment in which the handheld programming device 101 sends instructions via an infrared transmission. Although the descriptions in the flowcharts refer to an embodiment in which the handheld programming device 101 is used, one skilled in the art will recognize that other techniques for transmitting commands wirelessly can be used in place of infrared signals. For example, the handheld programming device 101 may transmit instructions via radio frequency transmissions. Many examples of display screens of the user interface provided on the handheld programming device 101 during the procedures of the flowcharts of the present invention are shown and described in the parent application having U.S. patent application Ser. No. 11/948,470.

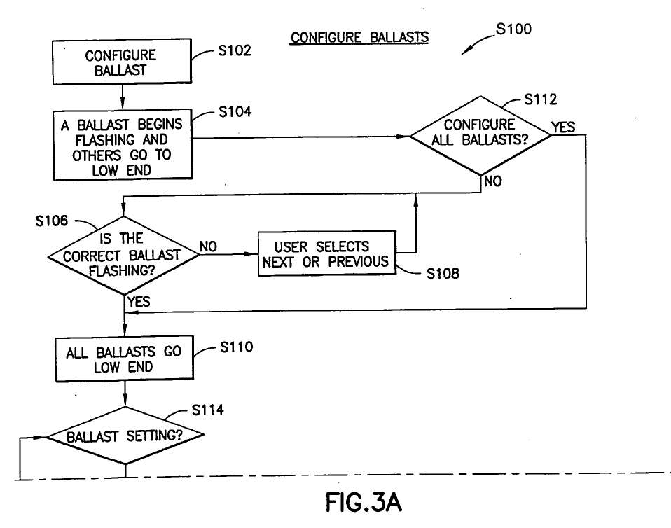

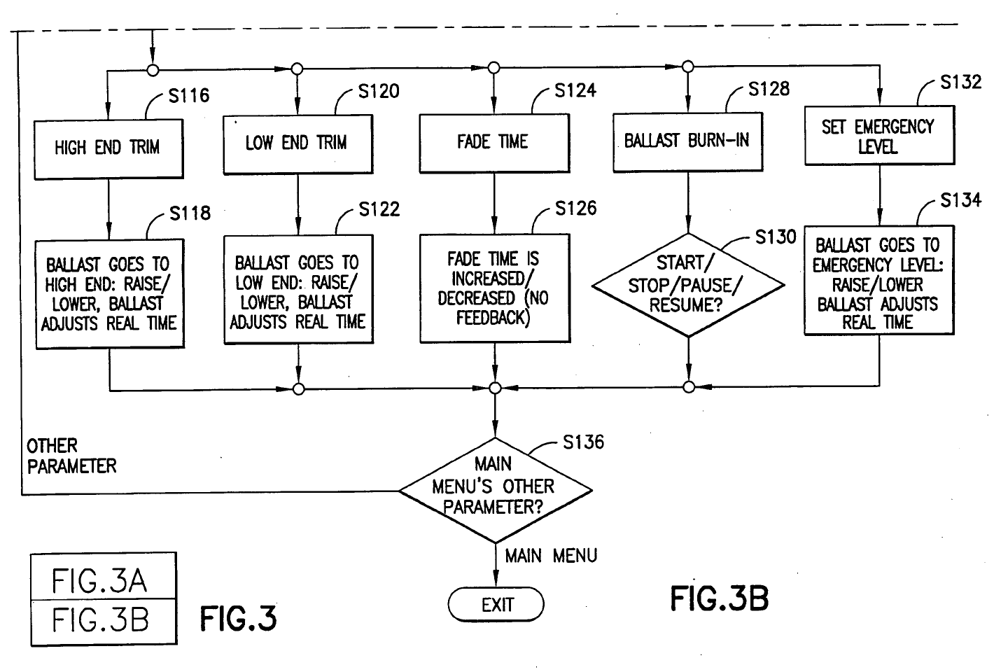

FIG. 3 is a flowchart of a ballast configuring process S100 for configuring one or more ballasts 102 using the handheld programming device 101 in accordance with the present invention. The ballast configuring process S100 shown in FIG. 3 is applicable for configuring the ballasts 102 after the ballasts have been physically installed and connected (i.e., wired) to the communication link 116 in which the user transmits instructions via the handheld programming device 101 to configure the ballasts. At step S102, the user points the handheld programming device 101 at the infrared receiver 104 attached to one of the ballasts 102 and selects a menu choice in the user interface provided on the handheld programming device to configure the ballasts. At step S104, the lamp connected to one of the ballasts 102 on the communication link 116 begins flashing. In an alternative embodiment, a light emitting diode (LED) on a lamp fixture associated with the ballast 102 could flash when the user makes a selection for configuring the ballasts such as in step S102.

At step S112, the user can select an option provided via the user interface on the handheld programming device 101 to configure all ballasts 102 installed on the communication link 116. Alternatively, the user can select a single ballast for configuration by observing the flashing at step S104 and making a determination whether the correct ballast is selected at step S106. If the user determines in step S106 that the desired ballast 102 is not causing the flashing, then the user selects a different ballast via the handheld programming control device 101 at step S108. For example, the user makes a selection using the graphical user interface on the handheld programming device 101 for the next ballast on the communication link 116 or a previous ballast on the communication link. The user is thereby able to select the desired ballast 102 for configuring by stepping through a list of all of the ballasts installed on the link. When the user has determined that the desired ballast 102 is selected for configuring, the user makes a selection on handheld programming device 101 to configure the respective device.

After the user has selected all ballasts at step S112 or selected a single ballast for configuration at step S106, all ballasts are instructed to operate at respective lowest settings (i.e., at the low-end intensity levels) at step S110. Accordingly, the user makes a selection to configure the selected ballast or all of the ballasts on the communication link 116. At step S114, the user makes selections on the handheld programming device 101 for configuring various aspects of ballasts 102. At step S116, the user makes a selection for setting the high-end intensity level (i.e., the high-end trim). The ballast 102 sets the lamp to the highest level, and the user adjusts the high-end trim by selecting choices on the handheld programming device 101, substantially in real time at step S118. For example, the user selects a graphical control, such as a button labeled with an up arrow or a down arrow, to increase or decrease the high-end trim. Alternatively, the user may select a button with a numeric value such as 100, 95, 90, 85, etc., to instruct the handheld programming device 101 to define the high-end trim for the ballasts 102.

At step S120, the user uses the handheld programming device 101 to define the low-end intensity level (i.e., the low-end trim) for the ballast 102. At step S122, thereafter, the ballast 102 automatically goes to its lowest level and the user selects options in the user interface provided on handheld programming device 101 to adjust the low-end trim to a preferred value. As described above with respect to setting the high-end trim, the user can select graphical icons in the form of buttons labeled with up and down arrows to increase or decrease low-end trim of the ballast 102 or the user can select a respective value (such as 5, 10, 15, etc.) to define a specific low-end trim substantially in real time.

Another option available to a user configuring a ballast in step S124 is to designate a fade time (which represents the amount of time in which a ballast fades from the initial operating level to the succeeding level) for a ballast 102 at step S124. The user then makes a selection to increase or decrease the fade time, for example, to one second, two seconds, five seconds or ten seconds, for the ballast 102 at step S126.

Another option available to a user provides for control of seasoning or “burn-in” of lamps at step S128. Lamp seasoning helps to prevent a decrease in lamp life, which may be caused by dimming a lamp too early after the lamp is first installed. After a user selects the option for a ballast bum-in at step S128, the ballast supplies a lamp with full power for a minimum amount of time, such as 100 hours. At step S130, the user is provided an option on the handheld programming device 101 to change the state of the bum-in process, i.e., to start, stop, pause and/or resume the bum-in process.

Another option available for configuring ballasts is to define an output level for the ballasts 102 during emergency conditions at step S132. For example, in case of a power outage or other emergency condition, the ballast 102 can be directed to operate at an emergency level as defined in step S132. The user is provided an option in step S134 to define a particular emergency level, such as 100%, 75%, 50%, 25%, or to leave the ballast unaffected. As described above with regard to setting the high-end trim and the low-end trim, the user is able to define the emergency levels of the ballasts 102 substantially in real time and observe the intensity of the light level during the setup process.

After a user has completed configuring one of the options (at steps S116, S120, S124, S128, or S132), the user can use the handheld programming device 101 to branch back to step S114 and select another parameter, or, alternatively, the user can exit the ballast configuring process S100 and return to a main menu level provided by the user interface on the handheld programming device at step S136. Thus, using the handheld programming device 101, a user can configure the ballasts 102 to define a high-end trim, a low-end trim, a fade time, a ballast burn-in state, and an output level during emergency conditions.

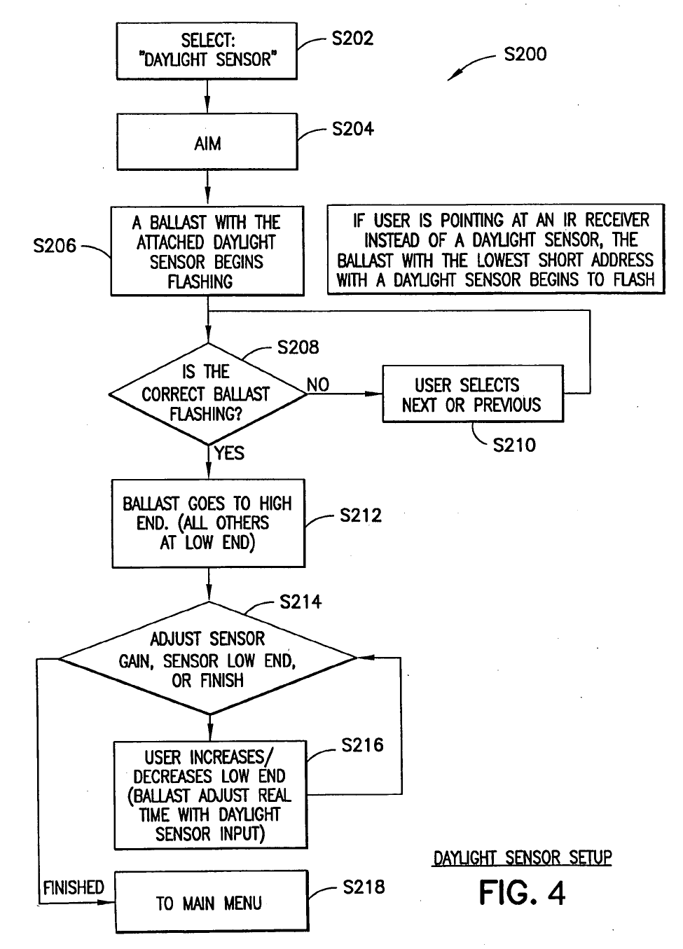

FIG. 4 is a flowchart of a photosensor configuration procedure S200 for configuring the photosensor 106 using the handheld programming device 101. At step S202, the user makes a selection on the handheld programming device 101 for configuring the photosensor 106. At step S204, the user aims the handheld programming device 101 at the IR receiver 104 connected to one of the ballasts 102 to send commands to the ballast for setting up the photosensor 106. At step S206, all ballasts 102 in the system go to, for example, the low-end intensity level, and the respective ballast that is attached to the photosensor 106 causes the connected lamp attached thereto to flash on and off. If the user is pointing at an IR receiver that is connected to a ballast 102 that is not connected to a photosensor 106, the ballast with the lowest short address that is connected to a photosensor 106 flashes.

At step S208, the user makes a determination whether the desired ballast 102 is flashing. If not, then at step S210, the user selects a different ballast 102, for example, by selecting next or previous on the handheld programming device 101. Alternatively, if the user determines that the correct ballast is flashing, then at step S212, the ballast attached to the daylight sensor controls the connected lamp to the high-end intensity level. In step S214, the user selects graphical controls on the handheld programming device 101 to adjust the sensor gain or the low-end trim. In this way, the user can define the degree of sensitivity of the photosensor 106 to detect when a particular amount of light, for example in a room, should cause a ballast 102 to turn on or off or dim to a dimmed level. When the user is satisfied with the settings of the photosensor 106, the user completes the process in step S218. Thus, using the graphical user interface provided on the handheld programming device 101, a user can configure the photosensor 106.

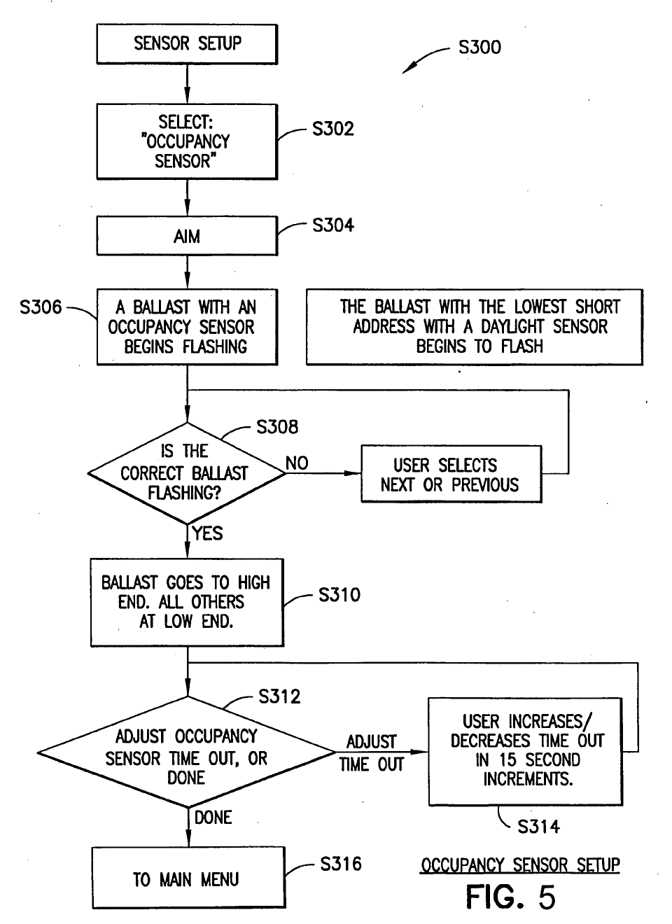

FIG. 5 is a flowchart of an occupancy sensor configuration procedure S300 for configuring the occupancy sensor 108 using handheld programming device 101. In the example flowchart shown in FIG. 5, a user defines an occupancy sensor time out value. At step S302, the user makes a selection on the handheld programming device 101 to configure the ballast 102 connected to the occupancy sensor 108. At step S304, the user aims the handheld programming device 101 at one of the IR receivers 104 and all ballasts 102 operate at the low-end intensity level with the exception of the ballast connected to the occupancy sensor 108. The ballast 102 connected to the occupancy sensor 108 begins flashing at step S306. Alternatively, the ballast 102 having the lowest short address with an occupancy sensor may begin to flash. At step S308, the user determines whether the correct ballast is flashing. If not, the user uses the handheld programming device 101 to select a different ballast 102 at step S310. If the user determines that the correct ballast 102 is flashing, then the user selects the ballast and the ballast operates at the high-end intensity level. The user uses the handheld programming device 101 to set an occupied level and an unoccupied level. At step S312, the user adjusts the occupancy sensor time out value, representing the amount of time after which the ballast 102 should cause connected lamp to turn off. For example, at step S314, the user increases or decreases the time out value by selecting a value on the handheld programming device 101. After the user is satisfied with the occupancy sensor time out value, selected in step S312, the user proceeds to step S316 and the process ends. Thus, using the handheld programming device 101, a user can make selections to configure the occupancy sensor 108.

In addition to configuring ballasts and sensor devices, the handheld programming device 101 provides an interface for grouping ballasts 102 to operate together in response to the photosensor 106, the occupancy sensor 108, the IR receivers 104, and the contact closures 112.

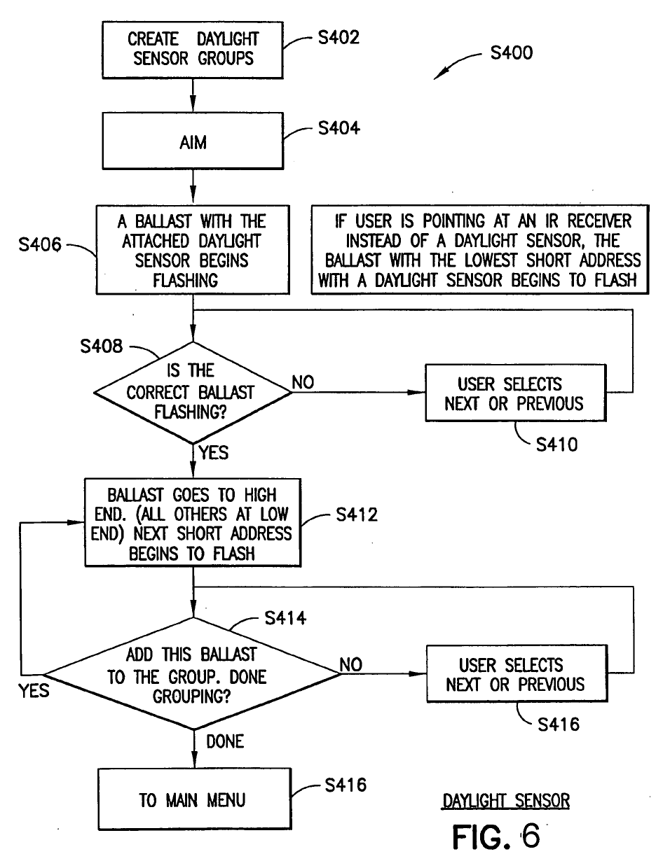

FIG. 6 is a flowchart of a photosensor grouping procedure S400 for configuring a group of ballasts with the photosensor 106. At step S402, a user makes a selection on the handheld programming device 101 for defining a daylight sensor group. At step S404, the user aims the handheld programming device 101 at one of the IR receivers 104. The ballast that is coupled to the photosensor 106 begins flashing at step S406. If the user is pointing at an IR receiver instead of a daylight sensor, the ballast with the lowest short address with a daylight sensor begins to flash. In step S408, the user makes a determination whether the ballast that is flashing is the desired one. If the user determines the ballast that is flashing is not the desired one, the user selects a different ballast 120 using the handheld programming device 101 at step S410, substantially as described above. When the user is satisfied that the correct ballast is flashing, the user selects the ballast and the ballast operates at the high-end intensity level at step S412. Alternatively, the ballast having the next short address begins to flash. The user observing the next flashing ballast makes a determination at step S414 whether that next ballast should be added to the group. If not, then the user selects a next or previous ballast at step S416, substantially as described above. If the user desires to add that ballast to the group, the user selects the ballast and the second ballast, thereafter, operates at the high-end intensity level and the process loops back to step S412. Accordingly, the ballast 102 having the next short address begins to flash, and the user either selects that ballast for the group, selects a different ballast for the group, or ends the process at step S418. Thus, using the handheld programming device 101, a user can configure a group of ballasts to operate with the photosensor 106.

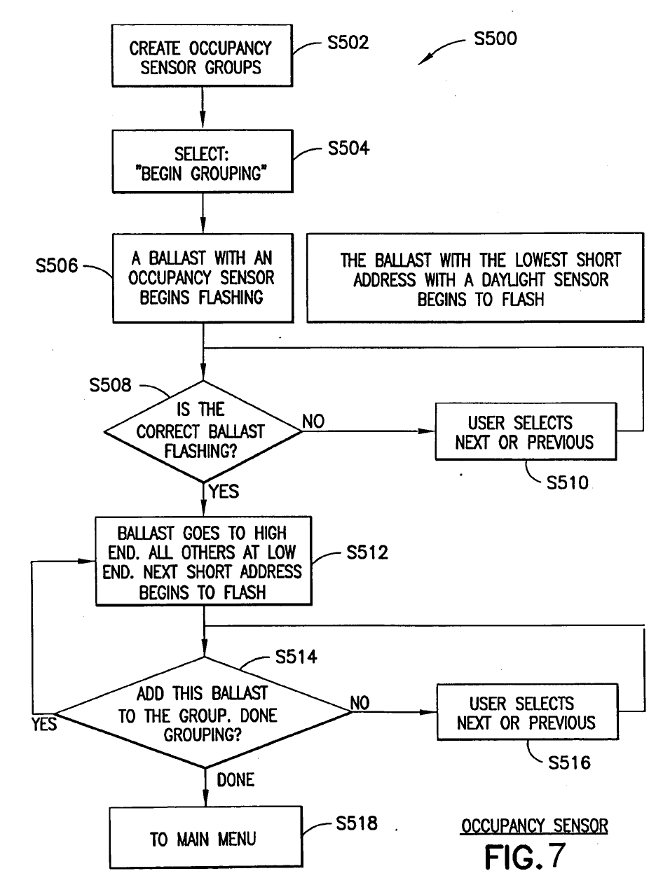

FIG. 7 is a flowchart of an occupancy sensor grouping procedure S500 for defining an occupancy sensor group using the handheld programming device 101. At step S502, the user selects a choice on the handheld programming device 101 for creating an occupancy sensor group. Thereafter, the user aims the handheld programming device 101 at the IR receiver 104 and selects “begin grouping” on the handheld programming device at step S504. At step S506, the ballast 102 that is electrically connected to the occupancy sensor 108 begins flashing the connected lamp. Alternatively, the ballast 102 with the lowest short address with a daylight sensor begins to flash. In step S508, the user makes a determination whether the ballast that is flashing is the correct one. If the user determines the ballast 102 that is flashing is not the correct one, the user selects a different ballast using the handheld programming device 101 at step S510, substantially as described above.

When the user is satisfied in step S508 that the correct ballast 102 is flashing, the user selects the ballast and the ballast operates at the high-end intensity level at step S512. Alternatively, the ballast 102 having the next short address begins to flash. The user observing the next flashing ballast makes a determination at step S514 whether that next ballast should be added to the group. If not, then the user selects a next or previous ballast at step S516, substantially as described above. If the user desires to add that ballast to the group, the user selects the ballast and the second ballast, thereafter, operates at the high-end intensity level and the process loops back to step S512. Accordingly, the ballast 102 having the next short address begins to flash, and the user either selects that ballast for the group, selects a different ballast for the group, or ends the process at step S518.

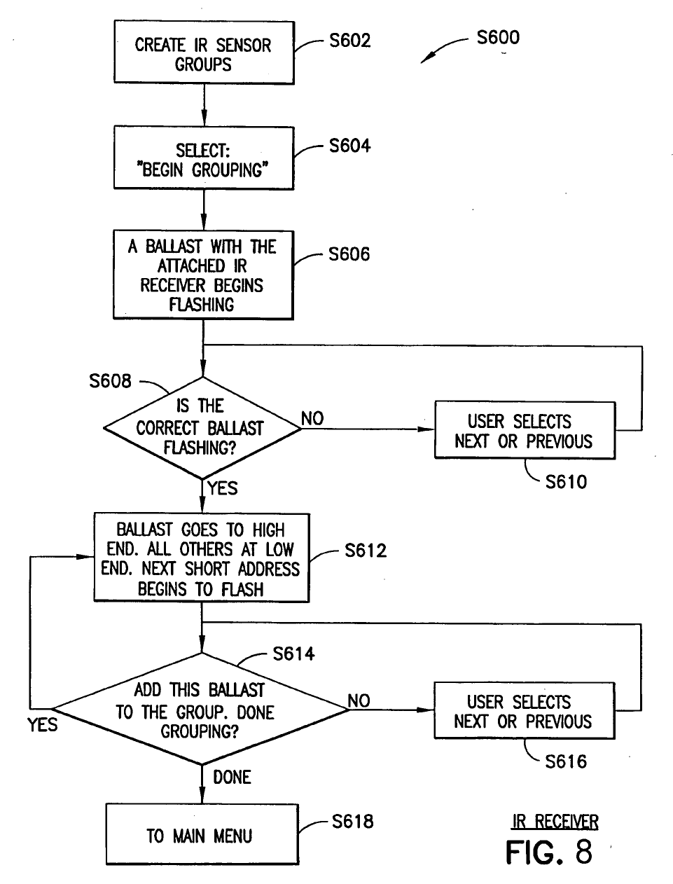

In addition to grouping ballasts 102 with the photosensor 106 or the occupancy sensor 108, the user may use the handheld programming device 101 to associate or group a plurality of ballasts 102 to receive commands via a single infrared receiving device 104. FIG. 8 is a flowchart of an infrared grouping procedure S600 for configuring a group of ballasts 102 with one of the infrared receivers 104. At step S602, a user makes a selection on the handheld programming device 101 for defining a group of ballasts 102 to operate via a single infrared receiver 104. At step S604, the user aims the handheld programming device 101 at the IR receiver 104 connected to the ballast 102 and selects “begin grouping” on the handheld programming device. The ballast 102 that is coupled to the infrared receiver 104 begins flashing at step S606. In step S608, the user makes a determination whether the ballast 102 that is flashing is the correct one. If the user determines in step S608 that the ballast that is flashing is not the correct one, the user selects a different ballast using the handheld programming device 101 at step S610, substantially as described above. When the user is satisfied that the correct ballast 102 is flashing, the user selects it and the ballast operates at the high-end intensity level at step S612. The user observing the next flashing ballast 102 makes a determination at step S614 whether that ballast should be added to the group. If not, then the user selects a next or previous ballast at step S616, substantially as described above. If the user desires to add that ballast to the group, the user selects the ballast and that ballast 102, thereafter, operates at the high-end intensity level and the process loops back to step S612. Accordingly, the ballast having the next short address begins to flash, and the user either selects that ballast for the group, selects a different ballast 102 for the group, or ends the process at step S618. Thus, using the handheld programming device 101, a user can associate a group of a plurality of ballasts 102 to receive commands via the infrared receiving device 104.

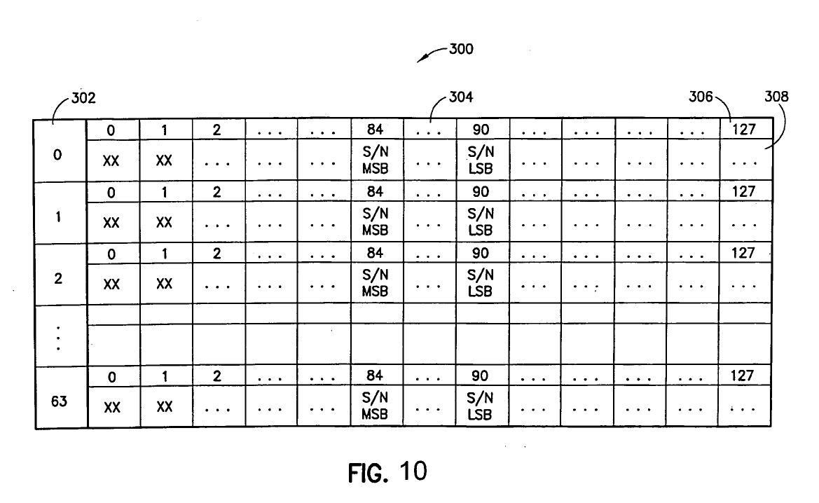

According to the first embodiment of the present invention, the handheld programming device 101 enables a user to replace and configure one or more ballasts 102. After a plurality of replacement ballasts 102 are physically installed on the communication link 116, a user uses the handheld programming device 101 to cause the bus supply 114 to reference information that relates to the replaced ballast 102 and that is stored in database 118. A new record for the new ballast 102 is created, and the setting and configuration information relating to the replaced ballast is copied to the record representing the new ballast. Thereafter, the information is transmitted over the communication link 116 to the new ballast 102 and all of the setting and configuration information from the replaced ballast 102 is automatically provided to the new ballast, and the new ballast performs exactly in the same way as the replaced ballast 102 did. By repeating the process, a plurality of ballasts 102 can be replaced in a single process. In a prior art DALI system replacement of a plurality of ballasts 102 is not possible because there would be no way to distinguish two or more unassigned ballasts from each other. The organization of the database 118 is discussed later herein with reference to FIG. 10.

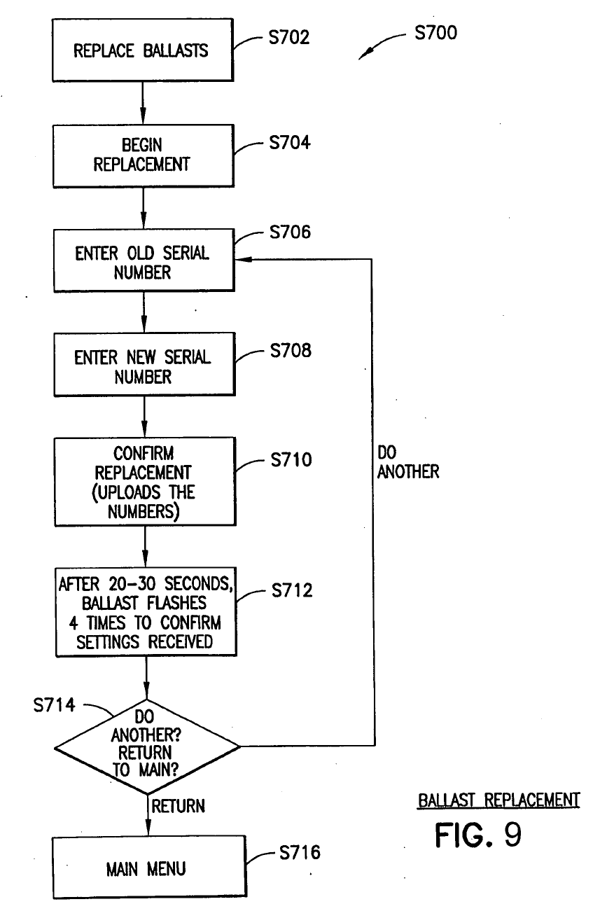

FIG. 9 is a flowchart of a manual ballast replacement procedure S700 for replacing one or a plurality of ballasts 102 using the handheld programming device 101 according to the first embodiment of the present invention. At step S702, the user makes a selection on the handheld programming device 101 to replace ballasts 102. At step S704, the user aims the handheld programming device 101 at one of the IR receivers 104, and selects an option to initiate a communication. In the embodiment shown, when communicating via the IR receiver 104, the user uses the handheld programming device 101 to enter the serial number of the replaced (old) ballast 102 at step S706. Thereafter, the user enters the serial number of the replacement (new) ballast 102 at step S708. When the replaced serial number and the replacement serial number are entered, the user transmits the information by selecting an option on the handheld programming device 101 to confirm the replacement serial numbers at step S710.

After a brief period of time (e.g., about ten seconds), the bus power supply 114 completes a process of transferring the setting and configuration information of the replaced ballast 102 to the replacement ballast, and the lamp associated with the replacement ballast flashes, for example, four times, at step S712. By flashing, the replacement ballast 102 alerts the user that the ballast is configured according to the replaced ballast. Thereafter, the user makes a determination, in step S714, whether another ballast 102 is to be replaced. If so, the process loops back to step S706, and the user identifies another ballast 102 to be replaced by its serial number. Alternatively, if the user does not desire to replace another ballast 102, the user selects an option to terminate the process and return, for example, to the main menu on the handheld programming device 101 at step S716. Thus, using the handheld programming device 101, a user can replace one or a plurality of ballasts 102 installed on the communication link 116.

In addition to configuring the ballasts 102 and the sensor devices 106 and 108, the present invention provides an interface for a user to use handheld programming device 101 to define the operation of the ballast 102 in response to the contact closure inputs 112. For example, using the handheld programming device 101, a user defines settings for a single ballast 102 or group of the ballasts 102 for a contact closure that is in a closed state. Alternatively, the user may define settings for a single ballast 102 or group of ballasts 102 for a contact closure that is in an open state. Moreover, a single ballast 102 or group of ballasts 102 can be so configured for a plurality of contact closures.

The user may also use the handheld programming device 101 to restore the database 118 on the bus supply 114. For example, in case the bus supply 114 fails and requires replacement, the database 118 on the replaced bus supply 114 may not be accessible. Once a replacement bus supply 114 is physically installed and powered, the user may select one or more controls on the handheld programming device 101 to instruct replacement bus supply 114 to build the database 118. Each ballast 102 stores in its respective memory the setting and configuration information for that ballast 102. For example, the values for high-end trim, the low-end trim, the emergency settings, the grouping settings or the like are stored in the memory of the ballast 102. During a bus supply replacement process, the bus supply 114 instructs each ballast 102 on the communication link 116, one at a time, to transmit its respective setting and configuration information to the replacement bus supply 114. The bus supply 114 assigns an identifier (i.e., the short address) to each ballast 102, and populates the database 118 with the respective information of each ballast.

FIG. 10 illustrates a representation of an example database record layout 300 for a data table storing setting and configuration information for ballasts 102, in accordance with an example database stored on bus supply 114. In the example shown in FIG. 10, a ballast short address field 302 stores a plurality of short addresses assigned by the bus supply 114 representing the ballasts 102 operating on the communication link 116. A data field 304 represents a long string of data, for example, 128 bytes in length, which stores various setting and configuration information for each respective ballast 102. Data shown in row 306 of data field 304 represents numbered bytes (e.g., 0-127) of information. Data shown in row 308 of data field 304 represents the data stored in the respective numbered bytes. In the example shown in FIG. 10, a serial number of a respective ballast 102 comprises seven bytes. As known in the art and as noted above, information is coded in the various bytes of serial number of ballast 102.

One skilled in the art will recognize that the bus supply 114 can communicate with the ballasts 102 quickly as a function of the short address values stored in the field 302. If the bus supply 114 was limited to communicating with the ballasts 102 exclusively via respective serial numbers, the data processing performance would be much slower because the bus supply 114 would be limited to searching through a 128-character byte array (or other data field) in order to locate a seven byte serial number. By indexing the data table 300 on the short address field 302, substantial performance gains are realized. Thus, for example, when a user selects on the handheld programming device 101 a control to lower the intensity settings of a group of the ballasts 102, the response time is extremely short and the user can view the reduction in intensity substantially in real time.

Other database tables (not shown) are may be stored in the database 118 on the bus supply 114. For example, a table may be maintained that stores data that correlate photosensor identifiers with ballast short addresses. Similarly, a table is maintained on the bus supply 114 that stores data that correlate occupancy sensor identifiers with ballast short addresses. Another table may be maintained that corresponds the IR receivers 104 with the wall controls 110. Another table may store information related to the grids 200 and corresponding ballast 102 values, such as described above with reference to FIG. 2. Another table may be maintained that stores ballast system information, such as values associated with the high-end trim, the low-end trim, the fade time, occupancy sensor mode information, time-outs, and the like. The data tables are formatted similarly to the example shown in FIG. 10. Therefore, a plurality of tables are may be stored and used by the bus supply 114 to enable the processes described herein, such as with reference to the handheld programming device 101.

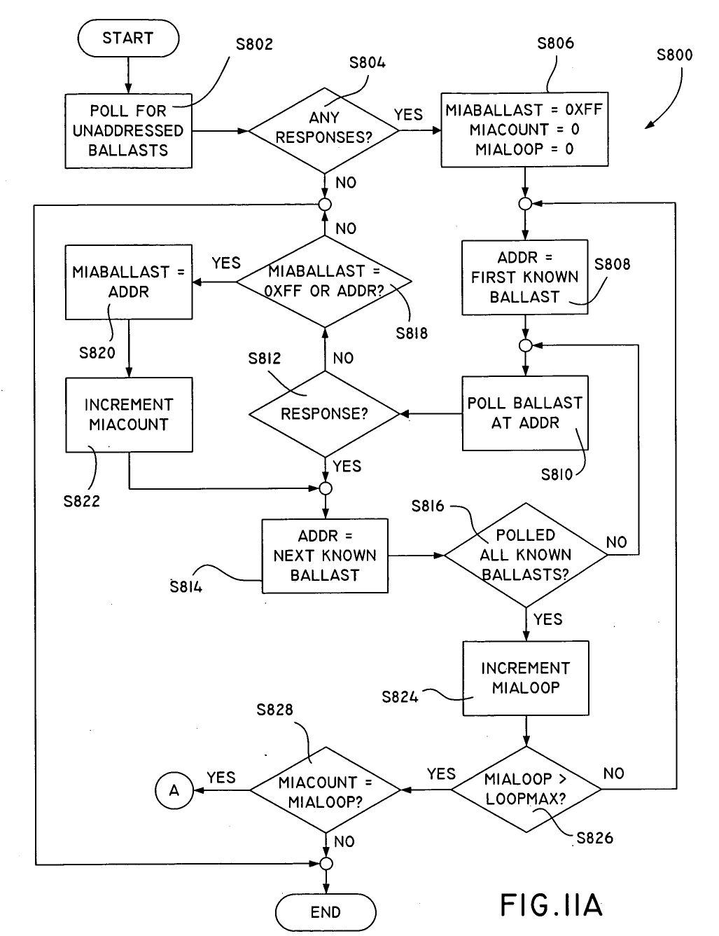

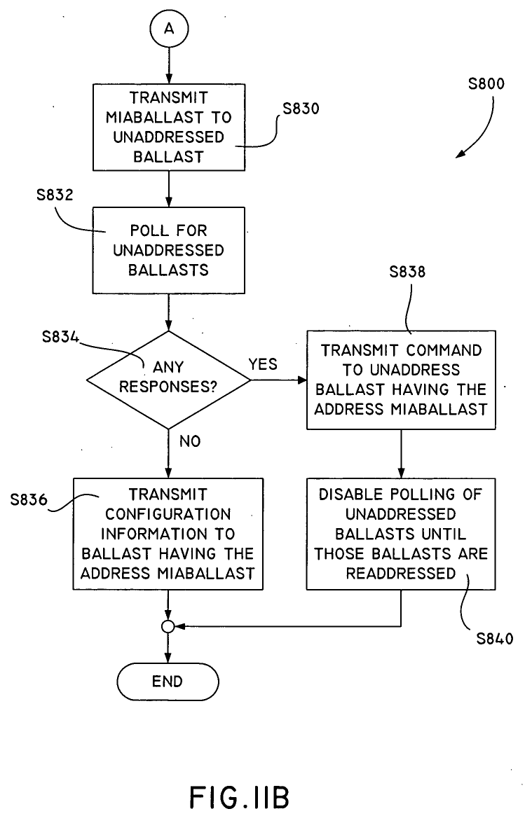

FIGS. 11A and 11B show a flowchart of an automatic single-ballast replacement procedure S800 executed periodically by the bus supply 114 according to the second embodiment of the present invention. The automatic single-ballast replacement procedure S800 allows for a signal new ballast 102 to be automatically programmed with the settings of a previous ballast if only one ballast is missing from the communication link 116. If there is more than one missing ballast (or non-functional ballast) or more than one new (i.e., unaddressed) ballast on the communication link 116, the bus supply 114 does not program any of the new ballasts with the settings of any of the missing ballasts. In this way, the bus supply 114 avoids programming a new ballast with incorrect settings (i.e., ballast settings that do not represent the previously-installed ballast that the new ballast is replacing).

Referring to FIG. 11A, the bus supply 114 first “polls” the communication link 116 for unaddressed ballasts at step S802 (i.e., the bus supply 114 transmits a query message to all ballasts 102 on the control link and those ballasts that do not have a short address respond to the query message). At step S804, the bus supply 114 determines if any responses have been received from any ballasts 102 that do not have a short address. Since the responding ballasts 102 transmit responses to the query message (transmitted at step S802) at random times and thus could transmit responses at the same time, the bus supply 114 may not be able to determine how many ballasts are responding at step S804. If there are no responses at step S804, the bus supply 114 concludes that there are no unaddressed ballasts 102 on the communication link 116 and the automatic single-ballast replacement procedure S800 simply exits.

However, if there is at least one response at step S804, the bus supply 114 initializes a number of variables MIABALLAST, MIACOUNT, and MIALOOP at step S806. The bus supply 114 uses the variable MIABALLAST to keep track of the short address of an indentified missing ballast, i.e., a ballast that has been removed from the communication link 116 or has failed. At step S808, the bus supply 114 sets a variable ADDR equal to the short address of the first known ballast 102 (i.e., the ballast having the lowest short address stored in memory of the bus supply 114). The bus supply 114 then polls (i.e., transmits a query message to) the ballast having the short address ADDR at step S810. If the bus supply 114 receives at step S812 a response to the query message (transmitted at step S810), the bus supply sets the variable ADDR equal to the short address of the next known ballast at step S814. If the bus supply 114 has not polled all of the known ballasts 102 at step S816, the automatic single-ballast replacement procedure S800 loops around and the bus supply polls the ballast having the short address ADDR at step S810.

If, at step S812, the bus supply 114 does not receive a response to the query message (transmitted at step S810), the bus supply determines at step S818 if the variable MIABALLAST is equal to 0xFF (i.e., the bus supply has not located a missing ballast yet) or if the variable MIABALLAST is equal to the variable ADDR (i.e., the bus supply has determined that only the ballast having address ADDR is missing). If the bus supply 114 does not receive a response from the ballast having address ADDR at step S812 and the variable MIABALLAST is equal to 0xFF or the variable ADDR at step S818, the bus supply 114 determines that the ballast having the short address ADDR is missing. Accordingly, the bus supply 114 sets the variable MIABALLAST equal to the variable ADDR at step S820 and increments the variable MIACOUNT at step S822. The bus supply 114 then sets the variable ADDR equal to the short address of the next known ballast at step S814 and the automatic single-ballast replacement procedure S800 loops around, so that the bus supply polls the next ballast at step S810 if the bus supply has not polled all of the known ballasts at step S816. If the variable MIABALLAST is not equal to zero or the variable ADDR at step S818 (i.e., the bus supply 114 has determined that there is more than one missing ballast), the automatic single-ballast replacement procedure S800 simply exits.

The bus supply 114 polls all of the ballasts 102 on the communication link 116 a predetermined number of times LOOPMAX (e.g., three times) during the automatic single-ballast replacement procedure S800 to make sure that only one ballast is missing on the communication link. The bus supply 114 uses the variable MIALOOP to keep track of how many times the bus supply has polled all of the ballasts. If the bus supply 114 has polled all of the known ballasts 102 at step S816, the bus supply increments the variable MIALOOP at step S824. If the variable MIALOOP is not greater than the predetermined number LOOPMAX at step 826, the automatic single-ballast replacement procedure S800 loops around and the bus supply 114 sets the variable ADDR to the short address of the first known ballast at step S808 and polls the first known ballast at step S810. If the variable MIALOOP is greater than the predetermined number LOOPMAX at step 826, the bus supply 114 determines if the variable MIACOUNT is equal to the variable MIALOOP at step S828 (to confirm that the identified missing ballast did not respond to the query message each time that the missing ballast was polled). If the variable MIACOUNT is not equal to the variable MIALOOP at step S828, the automatic single-ballast replacement procedure S800 exits. If the variable MIACOUNT is equal to the variable MIALOOP at step S828, the bus supply 114 concludes that the ballast 102 having the short address MIABALLAST is missing.

Since the bus supply 114 cannot determine if there is more than one unaddressed ballast at step S802 (as explained above), the bus supply must determine if there are any more unaddressed ballasts 102 on the communication link 116 after finding a missing ballast. Specifically, at step S830 of FIG. 11B, the bus supply 114 transmits the short address MIABALLAST to the unaddressed ballast (determined at step S804) to assign the unaddressed ballast the short address MIABALLAST. The bus supply 114 then polls (i.e., transmits a query message on) the communication link 116 for more unaddressed ballasts 102 at step S832. If, at step S834, the bus supply 114 does not receive any responses to the query message (transmitted at step S832), the bus supply determines that the indentified unaddressed ballast is the only unaddressed ballast on the communication link 116. Accordingly, the bus supply 114 transmits the ballast configuration information associated with the short address MIABALLAST in the database 118 to the ballast having the short address MIABALLAST at step S836 and the automatic single-ballast replacement procedure S800 exits.

However, if the bus supply 114 receives any responses to the query message (transmitted at step S832) at step S834, the bus supply determines that the identified unaddressed ballast is not the only unaddressed ballast on the communication link 116. Accordingly, the bus supply 114 will “undo” the address assignment completed in step S830. Specifically, the bus supply 114 transmits a command to unaddress the ballast having the short address MIABALLAST at step S838. The ballast having the short address MIABALLAST will then delete the short address from memory in response to receiving the command transmitted at step S838. Next, the bus supply 114 disables polling of the unaddressed ballasts at step S840 until those ballasts are readdressed, and the automatic single-ballast replacement procedure S800 exits.

Thus, the automatic single-ballast replacement procedure S800 of FIGS. 11A and 11B allows the bus supply 114 to automatically program a newly-installed ballast if only one ballast is unaddressed on the communication link 116 and only one ballast is missing from the communication link. The bus supply 114 is further operable to undo a completed address assignment if the bus supply determines that there are more unaddressed ballasts on the communication link 116. While the single-ballast replacement procedure S800 has been described as executed by the bus supply 114, the single-ballast replacement procedure could alternatively be executed by one of the ballasts 102.

Even though the present invention has been described with reference to the ballasts 102 for controlling the intensity of a connected fluorescent lamp, the methods of the present invention could be applied to load control systems comprising other types of load control devices, such as, for example, a dimmer switch for adjusting the intensity of a lighting load, a fan-speed control for controlling a fan motor, a driver for a light-emitting diode (LED) light source, an electronic drive unit for controlling the position of a motorized window treatment, and a non-dim electronic switch for simply switching an electronic load on and off.

Although the present invention has been described in relation to particular embodiments thereof, many other variations and modifications and other uses will become apparent to those skilled in the art. Therefore, the present invention should not be limited by the specific disclosure herein.

What is claimed is:

1. A method for replacing a previously-installed lighting control device with a new lighting control device in a lighting control system comprising a controller interconnected to the new lighting control device by a communication link, the previously-installed lighting control device having a short address associated therewith, the method comprising the steps of:
storing the short address and configuration information of the previously-installed lighting control device in a memory of the controller;
installing the new lighting control device in place of a previously-installed lighting control device;
the controller automatically assigning the short address of the previously-installed lighting control device to the new lighting control device;
the controller subsequently determining if there are unaddressed lighting control devices on the communication link;
the controller transmitting the configuration information associated with the previously-installed lighting control device to the new lighting control device in response to determining that there are not unaddressed lighting control devices on the communication link; and
the controller unassigning the short address from the new lighting control device in response to determining that there are unaddressed lighting control devices on the communication link.

2. The method of claim 1, further comprising the steps of:
the controller automatically determining if there are unaddressed lighting control devices on the communication link prior to the controller automatically assigning the short address of the previously-installed lighting control device to the new lighting control device; and
the controller automatically determining if there are missing lighting control devices on the communication link prior to the controller automatically assigning the short address of the previously-installed lighting control device to the new lighting control device.

3. The method of claim 2, wherein the controller determines that the previously-installed lighting control device is missing from the communication link by transmitting a query message to the previously-installed lighting control device and subsequently not receiving a response to the query message.

4. The method of claim 3, wherein the controller determines that the previously-installed lighting control device is missing from the communication link by transmitting a plurality of query messages to the previously-installed lighting control device and not receiving a response to any of the query messages.

5. The method of claim 3, wherein the controller determines that the new lighting control device is unaddresssed by transmitting a query message for unaddressed lighting control devices and subsequently receiving a response to the query message from the new lighting control device.

6. The method of claim 2, wherein the controller automatically assigns the short address of the previously-installed lighting control device to the new lighting control device if the controller determines that there is only one missing load control device on the communication link.

7. The method of claim 1, wherein the step of the controller unassigning the short address from the new lighting control device further comprises the steps of:
the controller transmitting a digital message to the new lighting control device in response to determining that there are unaddressed lighting control devices on the communication link after assigning the short address to the lighting control device; and
the new lighting control device subsequently deleting the short address from memory.

8. The method of claim 1, wherein the new lighting control device and the previously-installed lighting control device comprise ballasts.

9. A lighting control system for controlling the intensity of a lighting load, the system comprising:
a lighting control device coupled to a communication link and operable to adjust the intensity of a lighting load; and
a controller coupled to the lighting control device via the communication link and having a memory for storing a short address and an associated confirmation information, the controller operable to automatically assign the short address to the lighting control device after the lighting control device is installed on the communication link;
wherein the controller is further operable to subsequently determine if there are lighting control devices on the communication link, to transmit the configuration information associated with the short address to the lighting control device in response to determining that there are not unaddressed lighting control devices the communication link, and to unassign the short address from the lighting control device in response to determining that there are unaddressed lighting control devices the communication link.

10. The system of claim 9, wherein the controller automatically determines if there are unaddressed lighting control devices on the communication link and if there are missing ballasts on the communication link prior to assigning the short address to the lighting control device.

11. The system of claim 10, wherein the controller determines that a previously-installed lighting control device is missing from the communication link by transmitting a query message to the previously-installed lighting control device and subsequently not receiving a response to the query message.

12. The system of claim 11, wherein the controller determines that the previously-installed lighting control device is missing from the communication link by transmitting a plurality of query messages to the previously-installed lighting control device and not receiving response to any of the query messages.

13. The system of claim 11, wherein the controller determines that the lighting control device is unaddresssed by transmitting a query message for unaddressed lighting control devices on the communication link and subsequently receiving a response to the query message from the lighting control device.

14. The system of claim 10, wherein the controller automatically assigns the short address to the new lighting control device if the controller determines that there is only one missing ballast on the communication link.

15. The system of claim 9, wherein the lighting control device comprises a ballast.

16. The system of claim 15, wherein the controller comprises a digital ballast controller.

17. The system of claim 9, wherein the controller comprises a bus supply.

18. The system of claim 9, wherein the controller transmits a digital message to the new lighting control device in response to determining that there are unaddressed lighting control devices the communication link after assigning the short address to the lighting control device, and the new lighting control device subsequently deletes the short system address from memory.

19. A method of automatically programming a lighting control system that comprises a first ballast and a bus supply interconnected by a communication bus, the method comprising the steps of:
providing the first ballast with a first ballast configuration information;
assigning the first ballast a first short address;
storing in the bus supply the first ballast configuration information and the first short address of the first ballast;
removing the first ballast from the lighting control system;
installing in the lighting control system a second ballast and a third ballast;
automatically determining that the first ballast has been removed from the lighting control system;
automatically determining that the second ballast has not been assigned a short address;
assigning the first short address of the first ballast to the second ballast in response to determining that the second ballast has not been assigned a short address and that the first ballast has been removed from the lighting control system;
subsequently transmitting the first short address to the second ballast;
subsequently determining that the third ballast has not been assigned a short address; and
unassigning the first short address from the second ballast in response to determining that the third ballast has not been assigned a short address.

20. The method of claim 19, further comprising the steps of:
transmitting a digital message to the second ballast in response to determining that the third ballast has not been assigned a system address; and
the second ballast subsequently deleting the first short address from memory.
